(19) United States
(12) Patent Application Publication
(10) Pub. No.: US 2004/0164007 A1
(43) Pub. Date: Aug. 26, 2004

(54) Center tube with integrated relief valve

(76) Inventor: Arun K. Bhardwaj, Fayetteville, NC (US)

Correspondence Address: CARLSON, GASKEY & OLDS, P.C., 400 WEST MAPLE ROAD, SUITE 350, BIRMINGHAM, MI, 48009, US

(21) Appl. No.: 10/374,404

(22) Filed: Feb. 26, 2003

(51) Int. Cl. B01D 35/02

(52) U.S. Cl. 210/97; 210/429; 210/437

(57) ABSTRACT

A fluid filter assembly including a canister having a canister wall, a first passage and a second passage. A center tube is disposed within the canister and defines a length between a first end and a second end. The center tube includes a center tube wall having a plurality of apertures and defining a central bore, which is aligned with and is in communication with the first passage. The center tube wall includes a resilient valve seam, which extends along the length of the center tube and has a closed position and an open position. A filter element is mounted on the center tube and is disposed within the canister. When the valve seam is in the open position, the bore is in unfiltered communication with the second passage through a gap formed at the valve seam.

### BACKGROUND OF THE INVENTION

1. Field of the Invention

The present invention relates to fluid filters, particularly, oil filters. More specifically, the present invention pertains to mechanisms for relieving pressure in fluid filters.

2. Description of the Related Art

Internal combustion engines are typically provided with a lubrication system for lubricating the moving parts of an engine with oil. Over time, the oil collects particulate impurities, which can cause damage to the moving parts of the engine. Such particulate impurities include metal from the wear of the engine, carbon from the combustion of fuel, and minerals from the dust in the intake air.

Oil filters are commonly included in lubrication systems for the purpose of filtering out such particles. These oil filters, generally, include a cylindrical canister, a center tube, and a filter element. The canister includes a cylindrical wall, a central fluid outlet and a plurality of fluid inlets. The filter element is mounted about the center tube and both the center tube and filter element are disposed within the canister. Oil circulates through the oil filter by first entering the canister from the engine via the fluid inlets. An anti-drainback valve is often included to keep the oil from exiting back through the fluid inlets. Oil then flows through the filter element and into the center tube through apertures in the center tube wall. The filtered oil then exits the filter through the central fluid outlet and flows to the engine.

When the filter element becomes clogged with particles or, as in the case of a cold start, when the oil is too cold and viscous, the oil cannot pass through the filter element. In this case, pressure builds in the canister outside the center tube and filter element. Consequently, oil filters are generally provided with a pressure relief valve by which the unfiltered oil bypasses the filter element and is recirculated to the engine, thereby relieving the pressure in the canister. Several different pressure relief valve mechanisms are known in the art. Many of these mechanisms are relatively complex spring-operated valves having one or more springs and intricate moving parts. Such mechanisms can be difficult and expensive to assemble. In addition, such mechanisms often have a wide and/or inconsistent range of pressure relief.

Other proposed pressure relief valve mechanisms use resilient check valves to provide pressure relief. In these systems, the check valves are made of a resilient material such as rubber. The resilient check valves are located near the fluid inlets and cover an unfiltered passage from the fluid inlets to the central fluid outlet when pressure is normal. When pressure increases, the resilient check valve deflects away from the passage allowing oil to flow directly from the fluid inlets to the central fluid outlet. Such resilient check valves may include additional rubber parts that may be difficult to assemble and may provide inconsistent pressure relief ranges.

Accordingly, a need remains for a fluid filter assembly that is relatively easy to assemble and that has an effective and relatively simple pressure relief mechanism.

### SUMMARY OF THE INVENTION

The present invention provides a fluid filter assembly comprising a canister having a canister wall, a closed end, and an opposite open end. The open end has a first passage and a second passage. A center tube is disposed within the canister and includes a center tube wall having a plurality of apertures and defining a central bore. The central bore is aligned with and in communication with the first passage. The center tube wall includes a first resilient portion and a second portion, which join to define a resilient valve seam. The resilient valve seam has a closed position and an open position. A filter element is mounted on the center tube and is disposed within the canister. When the valve seam is in the open position, the first resilient portion is in spaced relation to the second portion forming a gap therebetween. In this open position, the central bore is in un-filtered communication with the second passage through the gap formed at the valve seam.

In one embodiment, each of the first resilient portion and second portion extend inward into the central bore and define a contact surface. The contact surface of the first resilient portion abuts the contact surface of the second portion when the valve seam is in the closed position. When the valve seam is in the open position, the contact surface of the first resilient portion is in spaced relation to the contact surface of the second portion forming a gap therebetween and the central bore is in unfiltered communication with the second passage through the gap.

In another embodiment, each of the first and second portions defines a curled region curving inward into the central bore. The contact surface of each of the first and second portions is positioned on the curled region of each of the first and second portions.

In yet another embodiment of the present invention, each of the first and second portions defines a tab extending into the central bore, the contact surface of each of the first and second portions is positioned on the tab of each of the first and second portions.

In still another embodiment of the present invention, each of the first and second portions defines an angled region angling inward into the central bore and a tab extending from the angled region into the central bore. The contact surface of each of the first and second portions is positioned on the tab of each of the first and second portions.

The present invention also provides a relief valve for a fluid filter assembly having a canister including a canister wall, a first passage, and a second passage; and a filter element disposed within the canister. The relief valve comprises a center tube disposable within the canister, the center tube including a center tube wall having a plurality of apertures and defining a central bore. The central bore is alignable with and communicable with the first passage. The center tube wall includes a first resilient portion and a second portion, which may be resilient similar to the first portion. The first and second portions join to define a resilient valve seam, which has a closed position and an open position. The central bore is filteredly communicable with the second passage through the plurality of apertures. When the valve seam is in the closed position, the first resilient portion abuts the second portion. When the valve seam is in the open position, the first resilient portion is in spaced relation to the second portion forming a gap therebetween, and the central bore is communicable with the second passage through the gap.

The present invention further provides a fluid filter assembly comprising a canister having a canister wall, a first passage and a second passage; a center tube disposed within the canister and defining a length between a first end and a second end, the center tube including a center tube wall having a plurality of apertures and defining a central bore, the central bore aligned with and in communication with the first passage, the center tube wall including a resilient valve seam extending along the length, the resilient valve seam having a closed position and an open position; and a filter element mounted on the center tube and disposed within the canister.

In a related embodiment the resilient valve seam includes a first resilient portion and a second resilient portion, the first resilient portion abuts the second resilient portion when the resilient valve seam is in the closed position. The first resilient portion is in spaced relation to the second resilient portion forming a gap therebetween, when the resilient valve seam is in the open position. When valve seam is in the open position, the central bore is in un-filtered communication with the second passage through the gap.

In a further embodiment, each of the first and second resilient portions extends inward into the central bore and defines a contact surface. The contact surface of the first resilient portion abuts the contact surface of the second resilient portion when the valve seam is in the closed position. The first and second resilient portions may comprise a variety of profiles, for example, curved, angled or tabbed.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a partial cross section of a fluid filter assembly according to the present invention;

FIG. 2 is a perspective view of a center tube of the fluid filter assembly of FIG. 1;

FIG. 3A is a partial cross section of the fluid filter assembly of FIG. 1 showing the relief valve according to the present invention in a closed position;

FIG. 3B is a partial cross section of the fluid filter assembly of FIG. 1 showing the relief valve according to the present invention in an open position;

FIG. 4A is a cross section view of a center tube relief valve according to the present invention in a closed position;

FIG. 4B is a cross section view of the center tube relief valve of FIG. 4A in an open position;

FIG. 5 is a cross section view of one embodiment of a center tube relief valve according to the present invention;

FIG. 6A is a cross section view of another embodiment of a center tube relief valve according to the present invention;

FIG. 6B is an enlarged view of the encircled region in FIG. 6A.

FIG. 7 is a cross section view of another embodiment of a center tube relief valve according to the present invention;

FIG. 8A is a cross section view of another embodiment of a center tube relief valve in closed position according to the present invention;

FIG. 8B is a cross section view of the embodiment of FIG. 8A in an open position;

FIG. 9A is a cross section view of another embodiment of a center tube relief valve in closed position according to the present invention; and

FIG. 9B is a cross section view of the center tube relief valve of FIG. 9A in open position.

### DETAILED DESCRIPTION

The embodiments hereinafter disclosed are not intended to be exhaustive or to limit the invention to the precise forms disclosed in the following description. Rather the embodiments are chosen and described so that others skilled in the art may utilize its teachings.

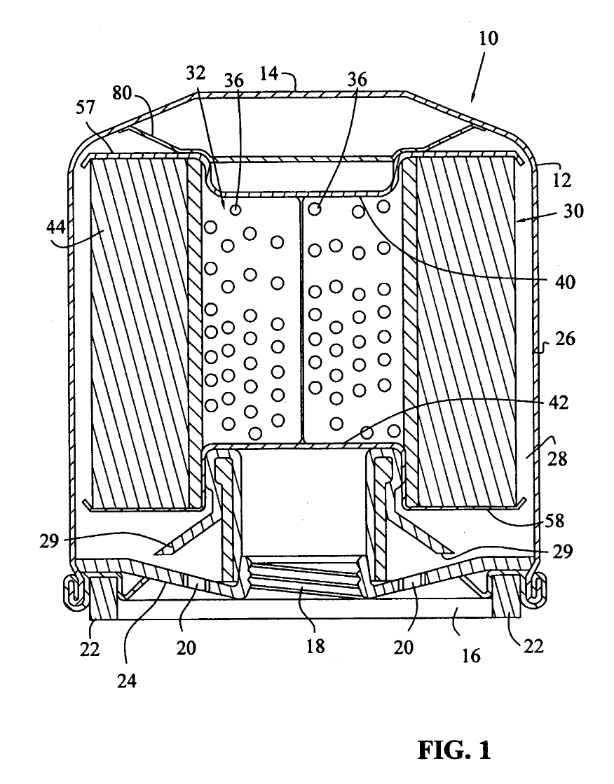

Referring to FIG. 1 oil filter assembly 10 generally includes canister 12 and element assembly 30. Canister 12 has closed end 14, open end 16, and cylindrical canister wall 26 defining hollow 28. At open end 16 is bottom assembly 24, which includes central fluid outlet or first passage 18 and at least one fluid inlet or second passage 20. First passage 18 is typically internally threaded for screwing oil filter assembly 10 onto a complementary threaded bolt (not shown) on the engine (not shown). Bottom assembly 24 also commonly includes seating gasket 22 for sealing oil filter assembly 10 to engine (not shown).

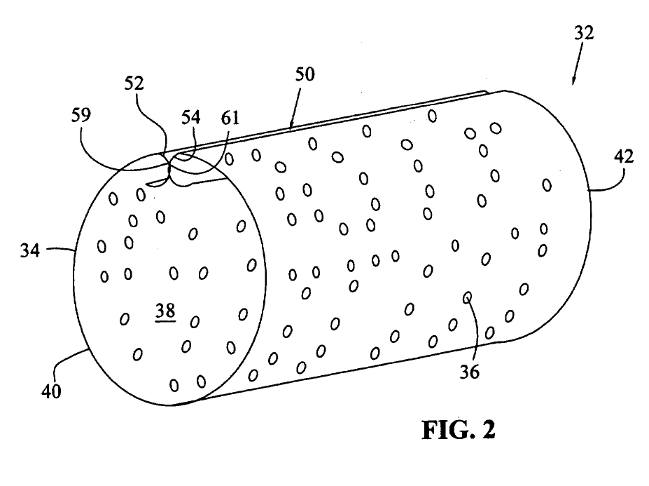

As illustrated in FIGS. 1 and 2, element assembly 30 is disposed within hollow 28 of canister 12 and generally includes cylindrical center tube 32, filter element 44 mounted about center tube 32 and pair of end caps 57, 58 mounted on each end of center tube 32. Element guide 80 is positioned between end-cap 57 and closed end 14 of canister 12, and anti-drain back valve 29 is positioned near second passage 20. Center tube 32 includes cylindrical tube wall 34, which defines bore 38 and has plural apertures 36. Bore 38 is aligned with and is in fluid communication with first passage 18. Bore 38 is in filtered fluid communication with second passage 20 through filter element 44 and plural apertures 36. Center tube 32 also includes first and second ends 40, 42 each of which sealingly engages end caps 57, 58, respectively, to prevent unfiltered fluid from entering bore 38.

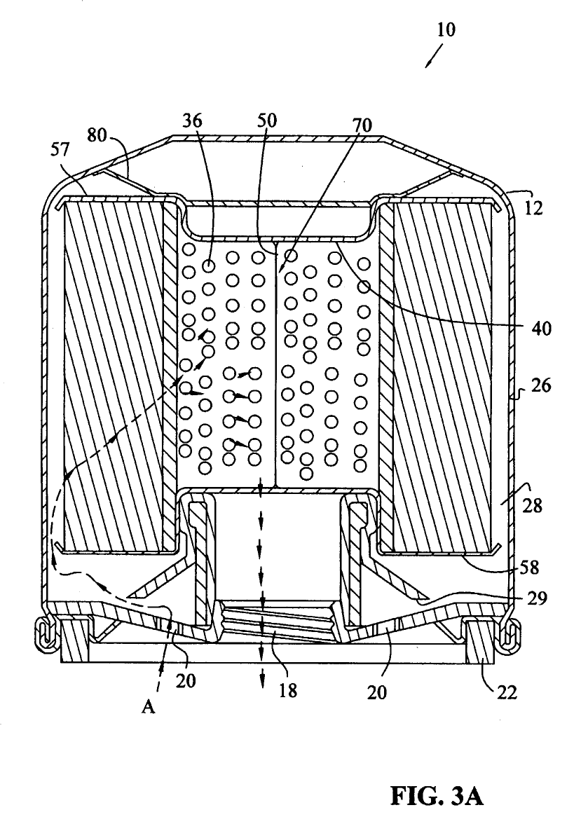

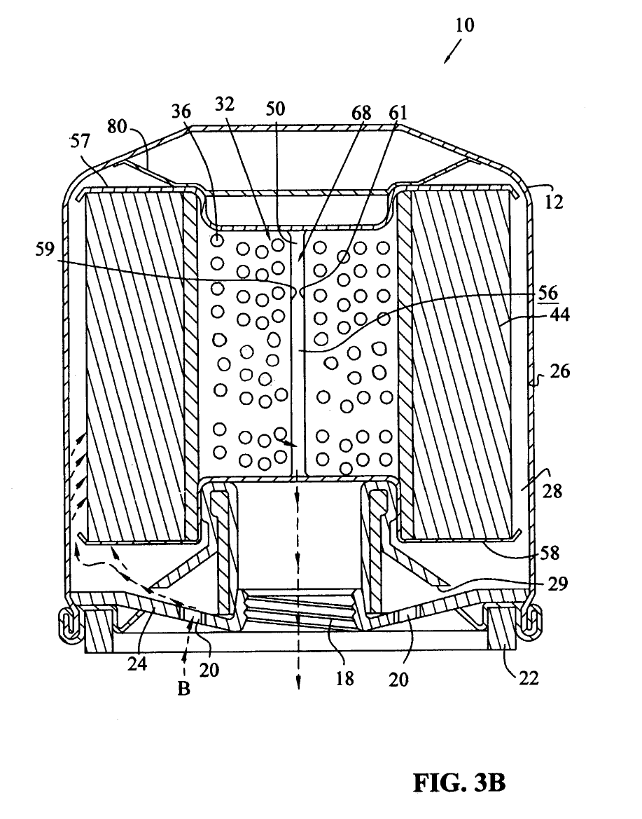

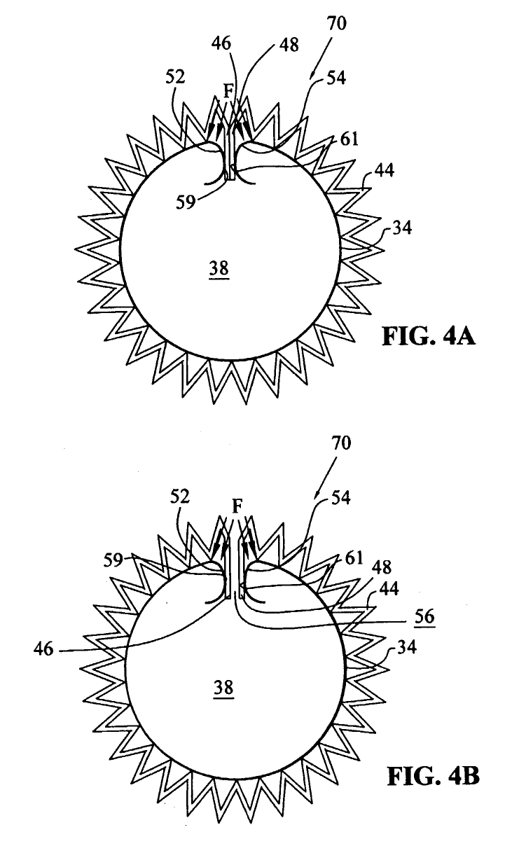

Referring now to FIG. 2, center tube 32 includes resilient bypass valve seam 50 extending the length of center tube 32 between first and second ends 40, 42 of center tube 32. Valve seam 50 includes first resilient portion 52 and second resilient portion 54, each of which extends into bore 38 and includes contact surface 59, 61, respectively. As illustrated in FIGS. 3A, 3B, 4A and 4B, valve seam 50 has an open position 68 and a closed position 70. In open position 68, shown in FIGS. 3B and 4B, first and second resilient portions 52, 54 are deflected inward into bore 38. In this configuration, first and second resilient portions 52, 54 are in spaced relation to one another, thereby forming bypass gap 56 therebetween. When valve seam 50 is in open position 68, bore 38 is in unfiltered fluid communication with second passage 20 through bypass gap 56. In closed position, shown in FIGS. 3A and 4A, contact surfaces 59, 61 of first and second resilient portions 52, 54 abut one another, thereby closing gap 56 and sealing bore 38 from unfiltered communication with second passage 20.

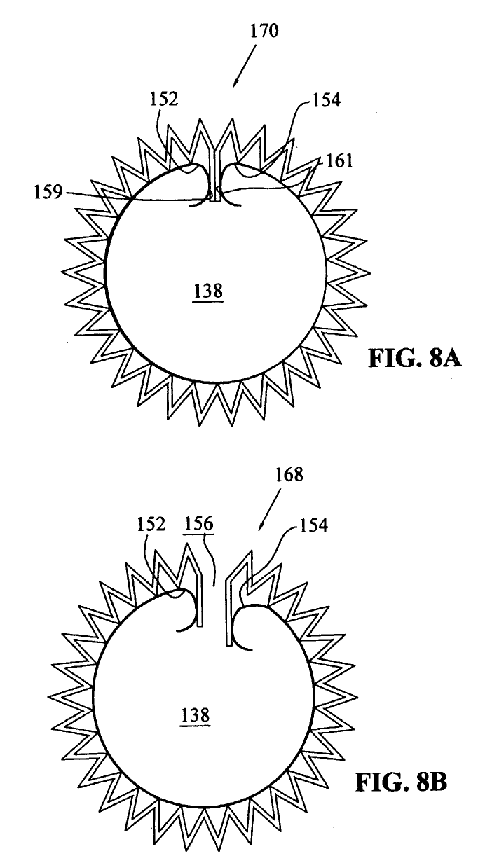

It should be understood that both portions of the valve seam need not be resilient. For instance, in an alternative embodiment exemplified in FIGS. 8A and 8B, valve seam 150 includes a first resilient portion 152 and a second portion 154. In open position 168, shown in FIG. 8B, first resilient portion 152 deflects inward into bore 138, thereby forming a bypass gap 156 between first resilient portion 152 and second portion 154. When valve seam 150 is in open position 168, bore 138 is in unfiltered fluid communication with second passage through bypass gap 156. In closed position, shown in FIG. 8A, contact surfaces 159, 161 of first resilient portion and second portions 152, 154 abut one another, thereby closing gap 156 and sealing bore 138 from unfiltered communication with second passage.

Referring back to FIGS. 4A and 4B, filter element 44 has first edge 46 and second edge 48. Although not necessary, in the illustrated embodiment, first edge 46 is attached to first resilient portion 52, while second edge 48 is attached to second resilient portion 54. In this configuration first and second edges 46, 48 of filter element 44 are pinched between abutting first and second resilient portions 52, 54 when valve seam is in closed position to further prevent unfiltered oil from seeping between abutting first and second resilient portions 52, 54 and to help secure filter element in place.

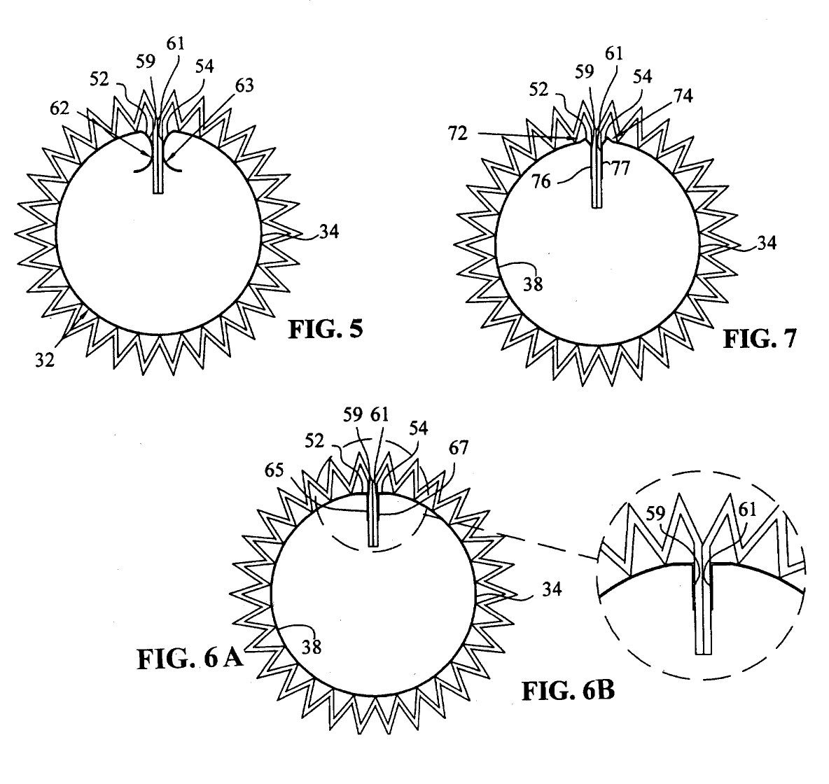

In one embodiment shown in FIG. 5, first and second resilient portions 52, 54 include curled regions 62, 63, respectively, which curve inward into bore 38. Contact surfaces 59, 61 are positioned on curled regions 62, 63, respectively, and have a curved shape.

It should be understood that the resilient portions need not be curved, but instead can have a variety of shapes and designs. For instance, in an alternative embodiment illustrated in FIGS. 6A and 6B, first and second resilient portions 52, 54 include tabs 65, 67 respectively, which extend from center tube wall 34 into bore 38 and are planar in shape. In this embodiment contact surfaces 59, 61 are located on tabs 65, 67 and have a planar shape.

In still another embodiment shown in FIG. 7, resilient portions 52, 54 have angled regions 72, 74, respectively, which angle inward into bore 38. Tabs 76, 77 extend further into bore 38 from angled regions 72, 74, respectively, and have a planar shape. In this embodiment, contact surfaces 59, 61 are located on tabs 76, 77, respectively, and have a planar shape.

Referring back to FIG. 3A, at normal operating pressures and temperatures, oil circulates through filter assembly 10 via route A. More specifically, unfiltered (dirty) oil flows from engine to canister 12 through second passage 20. The unfiltered oil then enters filter element 44 where the particulate impurities, such as metal, carbon, and dust, are removed from the oil and are absorbed by filter element 44. The filtered (clean) oil then flows into bore 38 through apertures 36 in center tube wall 34. From bore 38, the filtered oil flows through first passage 18 to the engine. Valve seam 50 naturally biases to closed position 70. Therefore, during normal operating pressures and temperatures, valve seam 50 is in closed position 70. In this closed position 70, shown in FIGS. 3A and 4A, gap 56 is closed and sealed, thereby preventing unfiltered oil from bypassing filter element 44 and flowing into bore 38 through valve seam 50.

When filter element 44 is clogged, such as when filter element becomes inundated with particulate impurities, or when the oil is too viscous to pass through filter element 44, as is the case during a cold start, pressure builds in the canister 12 between center tube wall 34 and canister wall 26. This pressure exerts a force in the direction of arrows F onto center tube wall 34 and valve seam 50, as illustrated in FIGS. 4A and 4B. When pressure reaches a certain predetermined limit, force F causes first and second resilient portions 52, 54 to move inward, thereby causing valve seam 50 to move to open position 68. In this open position 68, shown in FIG. 4B, gap 56 opens between first and second resilient portions 52, 54 and oil circulates through oil filter assembly 10 via route B. More specifically, unfiltered oil enters the canister 12 through second passage 20. The unfiltered oil then bypasses filter element 44 and flows into bore 38 through gap 56. The unfiltered oil then flows through first passage 18 to engine. When pressure decreases below the predetermined limit, such as when the oil warms and becomes less viscous, the force F is overcome by the natural bias of center tube wall 34 and valve seam 50 causing valve seam 50 to move to closed position 70, thereby closing gap 56 and preventing unfiltered oil from entering bore 38.

As illustrated in FIG. 2, center tube 32, including center tube wall 34 and valve seam 50, may be made of a single sheet of material that has an adequate level of resiliency. Examples of such materials include, but are not limited to, steel, spring steel, and plastics. The adequate level of resiliency of the center tube and of valve seam 50 is based on the desired predetermined pressure relief value. The level of resiliency can be customized by varying the type of material, the thickness of material, and the shape of the seam resilient portions. It is alternatively contemplated that center tube wall 34 and valve seam 50 may be made of separate materials. In this case, valve seam 50 is affixed to center tube wall 34 and may have a resiliency that is different from the center tube wall 34.

Although the fluid filter assembly of the present invention has been exemplified as an oil filter, it is contemplated that the fluid filter assembly of the present invention can be used in other filtering applications, as well. Furthermore, it is also contemplated that the fluid filter assembly of the present invention may be configured to accommodate a device in which the fluid flows in the opposite direction. In this case, unfiltered fluid would flow from the engine/device to the fluid filter assembly through the first passage and then back to the engine/device from the fluid filter assembly through the second passage.

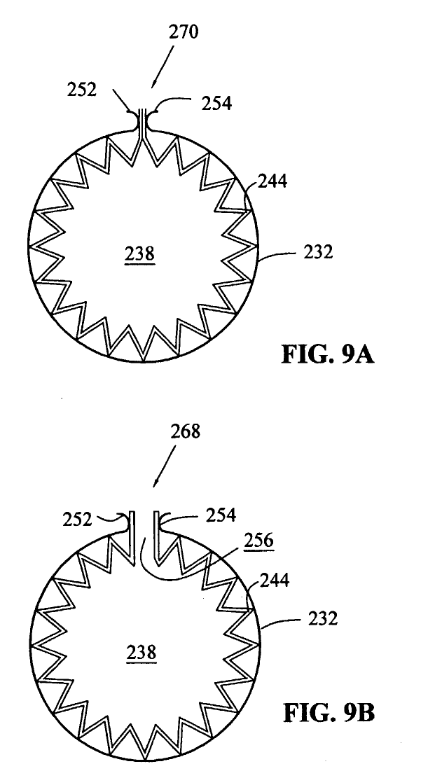

To accommodate this reverse flow, first and second resilient portions 252, 254 curl outward from bore 238, and filter element 244 is mounted on the interior of center tube 232, as is illustrated in FIGS. 9A and 9B. At normal operating pressures and temperatures, fluid flows from engine/device to bore 238 through the first passage. The unfiltered oil then enters filter element 244 where the particulate impurities are absorbed by filter element 244. The filtered fluid then flows from bore 38 through apertures in center tube 232 to the second passage, and then to the engine/device. At normal operating pressures and temperatures, first and second resilient portions 252, 254 naturally bias toward each other to closed position 270, shown in FIG. 9A, thereby preventing unfiltered oil from bypassing filter element 44.

When filter element 244 becomes clogged, or when the fluid is too viscous to pass through filter element 244 pressure builds in bore 238. This pressure exerts an outward force on center tube 32 causing first and second resilient portions 252, 254 to move to open position 268, illustrated in FIG. 9B. In this open position 268, gap 256 opens between first and second resilient portions 252, 254 and unfiltered fluid circulates through gap 256. When pressure decreases the force is overcome by the natural bias of first and second resilient portions 252, 254, thereby causing first and second resilient portions 252, 254 to move to closed position 270 and closing gap 256.

Due to the nature of the material and the design of the center tube relief valve seam, the present invention offers a narrow and consistent range of pressure relief. In addition, because the pressure relief valve mechanism is built into the center tube, the present fluid filter is relatively easy and inexpensive to assemble.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A fluid filter assembly comprising:
a canister having a canister wall, a closed end, and an opposite open end, said open end having a first passage and a second passage;
a center tube disposed within said canister, said center tube including a center tube wall having a plurality of apertures and defining a central bore, said central bore aligned with and in communication with said first passage, said center tube wall including a first resilient portion and a second portion, said first and second portions joining to define a resilient valve seam, said resilient valve seam having a closed position and an open position; and
a filter element mounted on said center tube and disposed within said canister.

2. The fluid filter assembly of claim 1 wherein said second portion is resilient.

3. The fluid filter assembly of claim 1 wherein, when said valve seam is in said open position, said first resilient portion is in spaced relation to said second portion forming a gap between said first and second portions, and said central bore is in unfiltered communication with said second passage through said gap formed at said valve seam in said open position.

4. The fluid filter assembly of claim 1 wherein each of said first and second portions extends inward into said central bore and defines a contact surface, said contact surface of said first resilient portion abutting said contact surface of said second portion when said valve seam is in said closed position.

5. The fluid filter assembly of claim 3 wherein, when said valve seam is in said open position, said contact surface of said first resilient portion is in spaced relation to said contact surface of said second portion forming a gap therebetween and said central bore is in unfiltered communication with said second passage through said gap.

6. The fluid filter assembly of claim 3 wherein said filter element having a first edge and a second edge, said first edge of filter element attached to said first resilient portion and said second edge of filter element attached to said second portion such that said first and second edges of said filter element are disposed between said abutting contact surfaces of said first and second portions.

7. The fluid filter assembly of claim 3 wherein each of said first and second portions defines a curled region curving inward into said central bore, and said contact surface of each of said first and second portions is positioned on said curled region of each of said first and second portions, respectively.

8. The fluid filter assembly of claim 3 wherein each of said first and second portions defines a tab extending into said central bore, said contact surface of each of said first and second portions positioned on said tab of each of said first and second portions, respectively.

9. The fluid filter assembly of claim 3 wherein each of said first and second portions defines an angled region angling inward into said central bore and a tab extending from said angled region into said central bore, said contact surface of each of said first and second portions positioned on said tab of each of said first and second portions, respectively.

10. The fluid filter assembly of claim 1 wherein said center tube defines a length extending between a first end and a second end of said center tube and said resilient valve seam extends along said length.

11. A relief valve for a fluid filter assembly having a canister including a canister wall, a first passage, and a second passage; and a filter element disposed within the canister, comprising:
a center tube disposable within the canister, said center tube including a center tube wall having a plurality of apertures and defining a central bore, said central bore alignable with and communicable with the first passage, said center tube wall including a first portion and a second portion, wherein at least one of said first and second portions is resilient, said first and second portions joining to define a resilient valve seam, said resilient valve seam having a closed position and an open position, and
wherein said central bore is filteredly communicable with the second passage through said plurality of apertures.

12. The relief valve of claim 11 wherein, when said valve seam is in said closed position, said first portion abuts said second portion; and when said valve seam is in said open position said first portion is in spaced relation to said second portion forming a gap therebetween and said central bore is communicable with the second passage through said gap.

13. A fluid filter assembly comprising:
a canister having a canister wall, a first passage and a second passage;
a center tube disposed within said canister and defining a length between a first end and a second end, said center tube including a center tube wall having a plurality of apertures and defining a central bore, said central bore aligned with and in communication with said first passage, said center tube wall including a resilient valve seam extending along said length, said resilient valve seam having a closed position and an open position; and
a filter element mounted on said center tube and disposed within said canister.

14. The fluid filter assembly of claim 13 wherein said resilient valve seam including a first resilient portion and a second resilient portion, said first resilient portion abutting said second resilient portion when said resilient valve seam is in said closed position, and said first resilient portion in spaced relation to said second resilient portion forming a gap therebetween when said resilient valve seam is in said open position.

15. The fluid filter assembly of claim 14 wherein said central bore is in filtered communication with said second passage through said plurality of apertures.

16. The fluid filter assembly of claim 14 wherein said central bore is in unfiltered communication with said second passage through said gap formed at said valve seam in said open position.

17. The fluid filter assembly of claim 14 wherein each of said first and second resilient portions extends inward into said central bore and defines a contact surface, said contact surface of said first resilient portion abutting said contact surface of said second resilient portion when said valve seam is in said closed position.

18. The fluid filter assembly of claim 17 wherein each of said first and second resilient portions is curved.

19. The fluid filter assembly of claim 17 wherein each of said first and second resilient portions is angled.

20. The fluid filter assembly of claim 17 wherein said filter element having a first edge and a second edge, said first edge attached to said first resilient portion and said second edge attached to said second resilient portion such that said first and second edges of said filter element are disposed between said abutting contact surfaces of said first and second resilient portions.
